(19) United States
(12) Patent Application Publication
(10) Pub. No.: US 2017/0209997 A1
(43) Pub. Date: Jul. 27, 2017

(54) Combinatorial objects formed by parts folding into pocket-knife like enclosures

(71) Applicant: David Suhami, Tel Aviv (IL)

(72) Inventor: Davod Suhami, Tel Aviv (IL)

(21) Appl. No.: 15/002,415

(22) Filed: Jan. 21, 2016

(51) Int. Cl. B25F 1/04; B26B 11/00

(52) U.S. Cl. CPC B25F 1/04; B26B 11/001

(57) ABSTRACT

The invention describes objects that may be formed by unfolding and combining in space several parts, initially folded into a pocket knife-like enclosure. The unfolded parts have their own specific utility, and may represent different animal limbs and when combined may form animal figurines in different postures; several of the figurines with different limb positioning may illustrate actions such as eating, sleeping or grazing.

This utility patent application is a continuation of and Claims priority from application Ser. No. 13/870,998 which claims priority from provisional application 61/640,065 from Apr. 30, 2012

### FIELD OF THE INVENTION

the invention relates to the field of Toys

### SUMMARY OF THE INVENTION

The invention is an assortment of parts folded in a common pocket-knife like enclosure that when unfolded in different combinations and angles form different objects.

For example when the parts folded into the common enclosure are animal body parts, the user may unfold out of the common longitudinal enclosure an animal head, a tail and two legs, all attached at one of their ends at different angles to said common enclosure that serves as the animal body, and thus form an animal figurine that may resemble a real animal or an imaginary one. Two or more of such figurines, may be grouped into “group postures”, for example as “huddling together”, “fighting” or “chasing stance” all by changing the angular positions of their legs and heads. The pocket-knife like enclosures may be in different sizes, for representing grown-up or young animals with different sized limbs. Some enclosures may have unfoldable parts that show the gender of the animal.

### DETAILED DESCRIPTION OF THE PREFERRED EMBODIMENTS

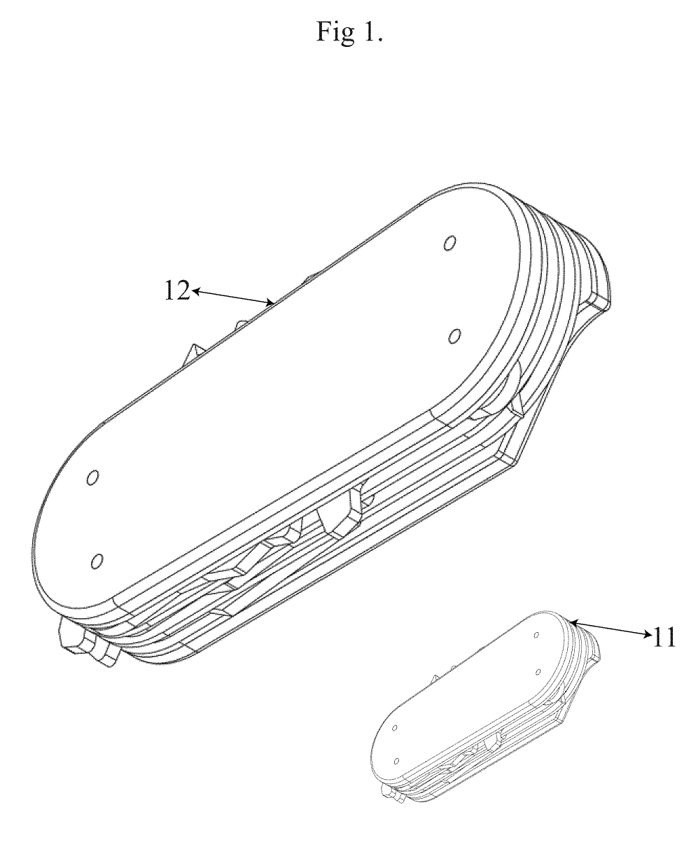

FIG. 1 shows two enclosures in different sizes 11 and 12 where each enclosure contains retrievable parts that are folded into them; the retrievable parts may form figurines in different size and different postures in order to visually convey movement.

The illustrated enclosures may have up to 7 retrievable parts which together with the enclosure that serves as the body, enable to build, 8 different animal figurines

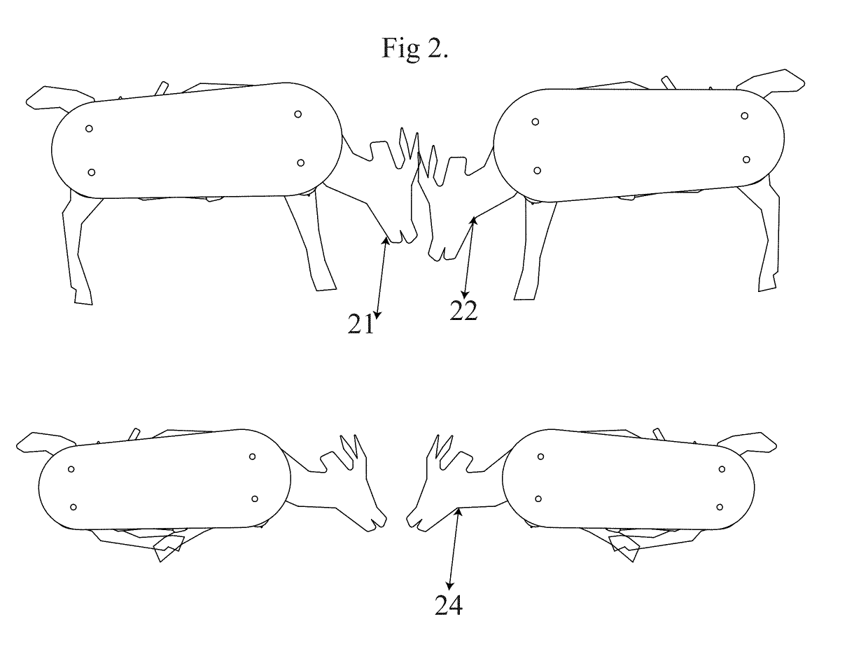

FIG. 2 illustrates 2 antelope figurines in a fighting posture 21, 22 or in a sleeping mode

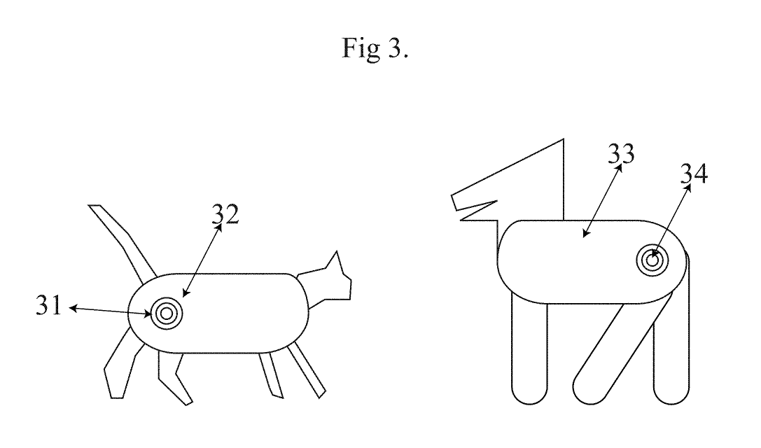

FIG. 3 shows a cat 32 and a dog 33 figurines built out of parts retrievable from a small and a large enclosure respectively. The enclosure also contain micro-speakers 32 and 34 that when activated, from a distance deliver a series of sound effects, each in response to the other's

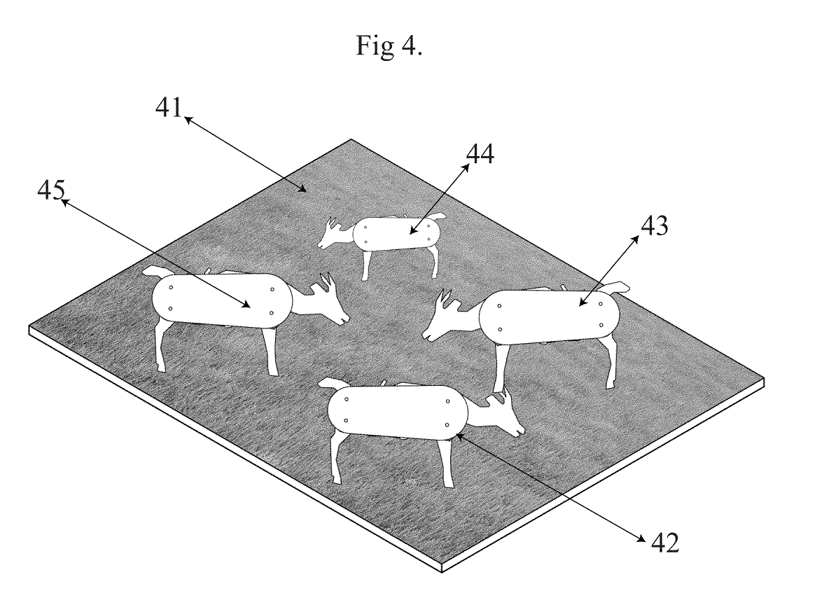

FIG. 4 illustrates a family of 3 antelope figurines 42,43, 45 and a baby antelope 44, each built out of 3 parts retrieved out of an enclosure that serves the body, grazing on a common green painted wooden plate 41

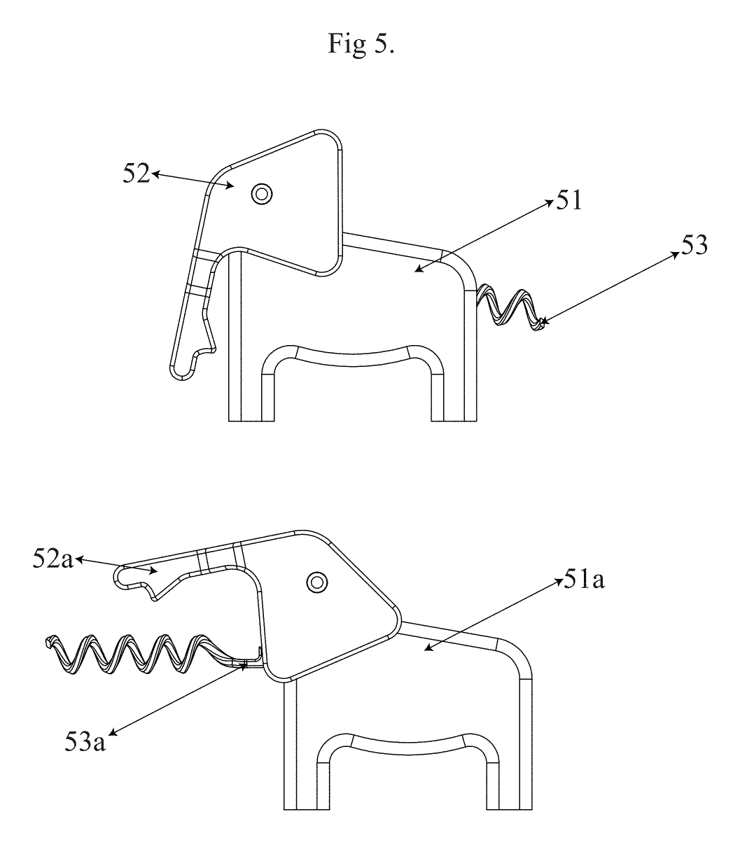

FIG. 5 illustrates an elephant figurine composed of 3 parts, the body 51, the Head and trunk 52 and a retrievable screw 53 that also serves as its tail. Lifting the elephant's trunk 52a, retrieves the screw that served as a tail, locks it mechanically within the elephant body 51a. The protruding screw 53a may then be used to penetrate the cork of the wine bottle by turning it clock-wise and using it as a corkscrew; pulling it will retrieve the cork. Turning the screw anti-clockwise and closing the trunk will introduce the screw back into the elephant body 51a and lock it in place as a tail 53.

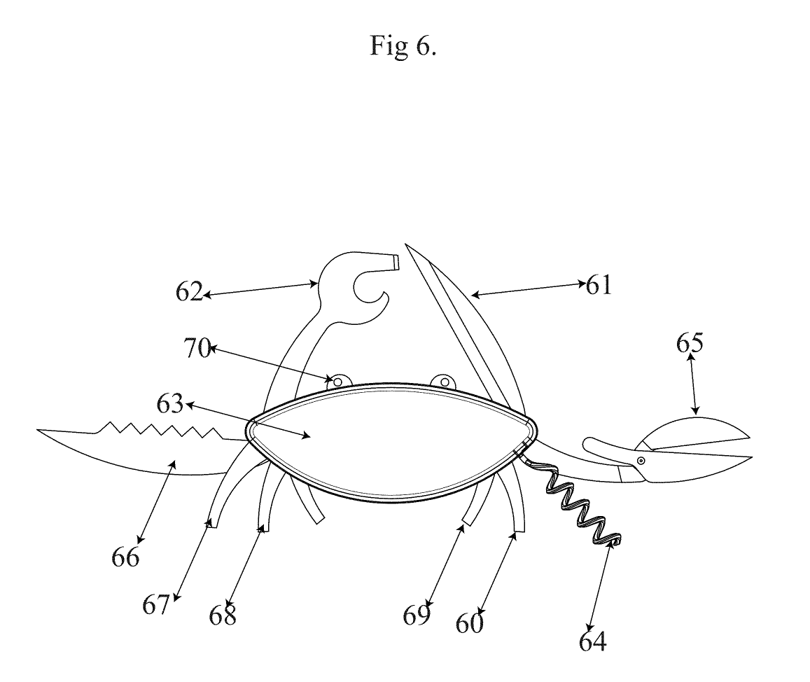

FIG. 6 illustrates a Crab-like figurine 63 with an oval body containing a “scissor” 65 that illustrates its mouth and a mini-saw 66 that illustrates its tail; 5 short retrievable “legs” structured as “mini-screw-drivers” 66,67, 68, 69,60 of various sizes suitable for manipulating eye-glasses screws, a knife 61, a wrench 62, a wine-bottle opener cork-screw 64 and 2 loops 91 suitable for attaching key-holders form a mini-toolbox.

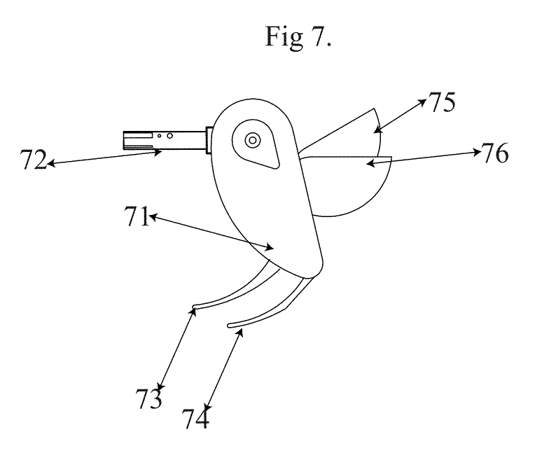

FIG. 7 illustrates an ornamental honey-bird figurine that holds in its body 71 an assortment of miniature small objects, such as rings, earrings, buttons, and keys and may be tucked in various 100 keyholes 72 making it visible to the eye. The body 71 may be opened and closed using the 2 springy legs 73, 74 of the figurine or the wings 75, 76.

There are multiple ways to realize the invention explained above, combine the differentiating features illustrated in the accompanying figures, and devise new embodiments of the method described, without departing from the scope and spirit of the present invention. Those skilled in the art will recognize that other embodiments and modifications are possible. While the invention has been described with respect to the preferred embodiments thereof, it will be understood by those skilled in the art that changes may be made in the above constructions and in the foregoing sequences of operation without departing substantially from the scope and spirit of the invention. All such changes, combinations, modifications and variations are intended to be included herein within the scope of the present invention, as defined by the claims. It is accordingly intended that all matter contained in the above description or shown in the accompanying figures be interpreted as illustrative rather than in a limiting sense.

1. A multi-functional folding tool comprising
“an enclosure, and,
“a plurality of retrievable parts each pivotally attached at one of end to said enclosure wherein some of said retrievable parts when unfolded to extend to outside said enclosure form together with the attached enclosure various combinatorial objects wherein,
at least some of the retrievable parts are shaped so as to also serve as useful utensils, each of said useful utensils defining a tool from a list comprising a knife, a letter opener, a nail file a screwdriver a wine bottle opener a beer bottle opener and a magnifying glass'
wherein said retrievable parts resemble animal limbs, heads and tails such that combinatorial objects resembling animal figurines are formed out of said unfolded parts and wherein,
same retrievable parts serve as limbs of different animal figurines and wherein,
said retrievable parts resembling animal limbs, when unfolded are positioned at different angular positions from the enclosure and wherein
said figurines convey visually to the viewer dynamic postures comprising one of running, sleeping, and eating.

2. A multi-functional folding tool comprising
an enclosure and a plurality of retrievable parts each pivotally attached at one of end to said enclosure wherein some of said retrievable parts when unfolded to extend to outside said enclosure, form together with the attached enclosure various combinatorial objects as in claim 1 wherein
said enclosures and the retrievable parts are of different sizes forming animal figurines of different sizes.

3. A multi-functional folding tool comprising
an enclosure and a plurality of retrievable parts each pivotally attached at one of end to said enclosure
wherein some of said retrievable parts when unfolded to extend to outside said enclosure form together with the attached enclosure various combinatorial objects as in claim 2 wherein
the retrievable parts of different sizes include parts that convey the gender of the animal figurine wherein,
said parts conveying the gender of the animal figurine include one of, mammaries and horns.

4. A multi-functional folding tool comprising
an enclosure and a plurality of retrievable parts each pivotally attached at one of end to said enclosure
wherein some of said retrievable parts when unfolded to extend to outside said enclosure form together with the attached enclosure various combinatorial objects as in claim 1 wherein
grouping several figurines each with different postures convey group actions wherein
said group actions comprise fighting, chasing, loving and grazing.

5. A multi-functional folding tool comprising an enclosure and a plurality of retrievable parts each pivotally attached at one of end to said enclosure wherein some of said retrievable parts when unfolded to extend to outside said enclosure form together with the attached enclosure various combinatorial objects as in claim 1 wherein said retrievable parts include sound receipt and delivery components embedded into a retrievable part wherein,
said sound receipt and delivery component is controlled from a source outside the enclosure.
